(19) United States
(12) Patent Application Publication
(10) Pub. No.: US 2012/0194647 A1
(43) Pub. Date: Aug. 2, 2012

(54) THREE-DIMENSIONAL MEASURING APPARATUS

(75) Inventor: Takumi Tomaru, Gunma (JP)

(73) Assignee: SONY CORPORATION, Tokyo (JP)

(21) Appl. No.: 13/357,042

(22) Filed: Jan. 24, 2012

(30) Foreign Application Priority Data
Feb. 1, 2011 (JP) 2011-019431

(51) Int. Cl. H04N 13/02

(52) U.S. Cl. 348/46; 348/E07.085

(57) ABSTRACT

A three-dimensional measuring apparatus includes: a projecting unit that projects a stripe to a projectable region which is a peripheral region of an intersection point on a measurement object when a vertical line is drawn down toward the measurement object; an imaging unit that includes a plurality of imaging regions at which the measurement object to which the stripe is projected is imaged within the projectable region; and a control unit that performs a process of three-dimensionally measuring the measurement object based on an image imaged by the imaging unit.

### CROSS REFERENCES TO RELATED APPLICATIONS

The present application claims priority to Japanese Priority Patent Application JP 2011-019431 filed in the Japan Patent Office on Feb. 1, 2011, the entire content of which is hereby incorporated by reference.

### BACKGROUND

The present disclosure relates to a three-dimensional measuring apparatus capable of measuring three-dimensionally a measurement object using a phase shift method or the like.

Hitherto, a method of analyzing images obtained by imaging a measurement object and inspecting the quality of the measurement object has been used as a method of inspecting the quality of a measurement object such as a print substrate. In two-dimensional image analysis, it is difficult to detect defects such as a crack and a cavity in a measurement object in a height direction. For this reason, a method of measuring the three-dimensional shape of a measurement object through three-dimensional image analysis and inspecting the quality of the measurement object has recently been used.

As the method of measuring the three-dimensional shape of a measurement object through image analysis, the phase shift method (time stripe analysis method) which is a kind of optical cutting method is widely used (for example, see Japanese Unexamined Patent Application Publication No. 2010-169433 (paragraphs [0033], [0042] to [0044], and FIG. 1).

The three-dimensional measuring apparatus disclosed in Japanese Unexamined Patent Application Publication No. 2010-169433 (paragraphs [0033], [0042] to [0044], and FIG. 1) includes a placing stand on which a print substrate printed with a solder is placed and an illumination device that illuminates the surface of the print substrate from the upper side of a slope with a stripe-shaped light pattern. Further, the three-dimensional measuring apparatus further includes a CCD camera that images a portion illuminated with the stripe-shaped light pattern from the immediate upper side of the print substrate and a control device that performs image processing or arithmetic processing.

The illumination device illuminates the print substrate with a light pattern by shifting the phase of the light pattern by a ¼ pitch. The CCD camera captures images of the print substrate illuminated with the light pattern when the phase of the light pattern is shifted and acquires a total of four images. The control device calculates the height of each of the coordinates of the print substrate by the phase shift method by processing the acquired four images.

### SUMMARY

Here, in an inspection region of a measurement object such as a print substrate, inspection objects such as a solder protruding from a reference surface or a cavity recessed from the reference surface are formed. When the inspection objects are illuminated with the stripe-shaped light pattern, a shadow may be formed on the surface of the measurement object. Further, when the inspection objects are illuminated with the stripe-shaped light pattern, halation may be formed depending on the angle of the light incident on the inspection object. In this case, the three- dimensional shape of the inspection object may not accurately be calculated.

It is desirable to provide a three-dimensional measuring apparatus capable of resolving a problem with shadow or halation.

According to an embodiment of the present disclosure, there is provided a three-dimensional measuring apparatus including a projecting unit, an imaging unit, and a control unit.

The projecting unit projects a stripe to a projectable region which is a peripheral region of an intersection point on a measurement object when a vertical line is drawn down toward the measurement object.

The imaging unit includes a plurality of imaging regions at which the measurement object to which the stripe is projected is imaged within the projectable region.

The control unit performs a process of three-dimensionally measuring the measurement object based on an image imaged by the imaging unit.

In the three-dimensional measuring apparatus, the projecting unit is capable of projecting the stripe to the projectable region which is the peripheral region of the intersection point on the measurement object when the vertical line is drawn down toward the measurement object. Accordingly, in this embodiment, the stripe can be projected in a wide range by the projecting unit. Further, the projectable region of the wide range is effectively used and the plurality of imaging regions are disposed in the projectable region. For example, by appropriately disposing the plurality of imaging regions in the projectable region and imaging the inspection region of the measurement object at these imaging regions, the problem with shadow or the problem with halation can be resolved with the inspection object in the inspection region. Alternatively, for example, when the measurement object has two or more inspection regions, the three-dimensional shapes of the plurality of inspection regions can be calculated at high speed by simultaneously locating the two or more inspection regions at two or more imaging regions and allowing the imaging unit to simultaneously image the inspection regions.

The three-dimensional measuring apparatus may further include a moving unit.

The moving unit moves relative positions of the measurement object with respect to the plurality of imaging regions.

In this case, the control unit may control the movement of the relative positions by the moving unit such that the moving unit moves one inspection region in the measurement object sequentially to two or more imaging regions among the plurality of imaging regions and control the imaging unit such that the imaging unit images the inspection region whenever the inspection region is matched with the positions of the imaging regions.

In the three-dimensional measuring apparatus, the relative positions of the measurement object with respect to the plurality of imaging regions can be moved and one inspection region in the measurement object can be imaged at each of the different imaging regions. Thus, by disposing the imaging regions at the positions for appropriately cancelling the shadow occurring in the inspection object in the inspection regions and imaging the one inspection region at each of the imaging regions, the problem with the shadow can be resolved.

Further, in the three-dimensional measuring apparatus, one inspection region can be imaged at each of the different imaging regions. For example, when the inspection region is imaged at a given imaging region, the problem with the halation can be resolved by imaging the inspection object at the different imaging regions even when the halation occurs.

When the three-dimensional measuring apparatus may further includes the moving unit, the control unit controls the movement of the relative positions by the moving unit such that the moving unit simultaneously moves two or more inspection regions in the measurement object to two or more imaging regions among the plurality of imaging regions and controls the imaging unit such that the imaging unit simultaneously images the two or more inspection regions.

In the three-dimensional measuring apparatus, the two or more inspection regions can simultaneously be located at the two or more imaging regions and can simultaneously be imaged by the imaging unit. Therefore, the three-dimensional shapes of the plurality of inspection regions can be calculated at high speed.

In the three-dimensional measuring apparatus, the control unit may switch between a first mode and a second mode.

In the first mode, the control unit controls the movement of the relative positions by the moving unit such that the moving unit moves one inspection region in the measurement object sequentially to two or more imaging regions among the plurality of imaging regions and controls the imaging unit such that the imaging unit images the inspection region whenever the inspection region is matched with the positions of the imaging regions.

In the second mode, the control unit controls the movement of the relative positions by the moving unit such that the moving unit simultaneously moves two or more inspection regions in the measurement object to two or more imaging regions among the plurality of imaging regions and controls the imaging unit such that the imaging unit simultaneously images the two or more inspection regions.

In the three-dimensional measuring apparatus, the control unit can arbitrarily switch between the first mode in which the problem with the shadow is resolved and the inspection region is accurately inspected and the second mode in which two or more inspection regions are simultaneously imaged at high speed by the imaging unit and the three-dimensional shapes of the inspection regions are calculated.

In the three-dimensional measuring apparatus, at least one of the plurality of imaging regions may be located at a position in a range of 180°±90° with respect to the other imaging regions in the projectable region. Thus, the influence of the shadow occurring in the inspection object can appropriately be excluded.

In the three-dimensional measuring apparatus, at least one of the plurality of imaging regions may be located at a position in a range of 180°±45° with respect to the other imaging regions in the projectable region. Thus, the influence of the shadow occurring in the inspection object can appropriately be excluded.

In the three-dimensional measuring apparatus, at least one of the plurality of imaging regions may be located at a position deviated from 0°, ±90°, and 180° in the projectable region. Thus, the influence of the halation can appropriately be excluded.

In the three-dimensional measuring apparatus, at least one of the plurality of imaging regions may be located at a position deviated from ±45° and ±135° in the projectable region. Thus, the influence of the halation can appropriately be excluded.

In the three-dimensional measuring apparatus, at least one of the plurality of imaging regions may be located at a position deviated from 0°, ±45°, ±90°, ±135°, and 180° in the projectable region. Thus, the influence of the halation can appropriately be excluded.

In the three-dimensional measuring apparatus, at least one of the plurality of imaging regions may be different from the other imaging regions in a distance between the imaging region and the intersection point in the projectable region. Thus, it is possible to dispose the imaging regions different from the other imaging regions in the measurement accuracy and the measurement range.

In the three-dimensional measuring apparatus, the imaging unit may include a plurality of imaging sections corresponding to the plurality of imaging regions.

In the three-dimensional measuring apparatus, the imaging unit may include an imaging section that is able to singly image two or more imaging regions among the plurality of imaging regions.

Thus, the cost can be reduced since the number of imaging sections can be reduced.

In the three-dimensional measuring apparatus, when the imaging unit includes the imaging section capable of singly imaging two or more imaging regions, the three-dimensional measuring apparatus may further include a reflection unit and a driving unit.

The driving unit drives the reflection unit so as to switch between a first incident state in which light from one of the plurality of imaging regions is incident on the imaging section and a second incident state in which light from another imaging region is guided to the imaging section by the reflection unit.

In the three-dimensional measuring apparatus, the projecting unit may include a mask that restricts the projection of the stripe so that the stripe is not projected to a region other than the plurality of imaging regions in the projectable region.

Thus, it is possible to prevent the measurement accuracy of the inspection region from deteriorating due to the fact that the stripe is projected to an unnecessary region in the projectable region and diffusely reflected light is incident to the imaging unit.

As described above, according to the embodiments of the present disclosure, there is provided the three-dimensional measuring apparatus capable of resolving the problem with shadow or halation.

Additional features and advantages are described herein, and will be apparent from the following Detailed Description and the figures.

### BRIEF DESCRIPTION OF THE FIGURES

FIG. 1 is a diagram illustrating a three-dimensional measuring apparatus according to an embodiment of the present disclosure;

FIG. 2 is a diagram illustrating an example of a measurement object to be three-dimensionally measured by the three-dimensional measuring apparatus;

FIG. 3 is a diagram illustrating an optical system of a projecting unit;

FIG. 4 is a plan view illustrating a light-shielding mask;

FIG. 5 is a plan view illustrating the shape of a stripe projected on a substrate and illustrating a relationship between a projectable region and an imaging region;

FIG. 6 is a flowchart illustrating a process of a control unit of the three-dimensional measuring apparatus according to an embodiment of the present disclosure;

FIG. 7 is a diagram illustrating the shape of a shadow formed by an inspection object such as a solder formed in an inspection region when the inspection region is located at a first imaging region;

FIG. 8 is a diagram illustrating the shape of a shadow formed by an inspection object when the inspection region is located at a second imaging region;

FIG. 9 is a diagram illustrating the locations of a plurality of imaging regions for excluding the influence of shadows and illustrating the shapes of the shadows formed when inspection objects are located at the imaging regions;

FIG. 10 is a diagram illustrating the shapes of shadows formed when the inspection objects are located at the imaging regions;

FIG. 11 is a diagram illustrating the shapes of shadows formed when the inspection objects are located at the imaging regions;

FIG. 12 is a diagram illustrating the shapes of shadows formed when the inspection objects are located at the imaging regions;

FIG. 13 is a diagram illustrating a plurality of imaging regions disposed in a projectable region according to another embodiment of the present disclosure;

FIG. 14 is a diagram illustrating the locations of a plurality of imaging regions for excluding the influence of halation and illustrating the influence of the halation when inspection objects are located at the imaging regions;

FIG. 15 is a diagram illustrating the influence of the halation when the inspection objects are located at the imaging regions;

FIG. 16 is a diagram illustrating the influence of the halation when the inspection objects are located at the imaging regions;

FIG. 17 is a diagram illustrating the influence of the halation when the inspection objects are located at the imaging regions;

FIG. 18 is a flowchart illustrating a process of a three-dimensional measuring apparatus according to another embodiment;

FIGS. 19A to 19D are diagrams illustrating the influence of the halation when the imaging regions are disposed at the positions deviated from 0°, ±45°, ±90°, ±135°, and 180°;

FIG. 20 is a diagram illustrating a plurality of imaging regions disposed in a projectable region according to still another embodiment; and

FIG. 21 is a diagram illustrating an example of an imaging section capable of singly imaging two or more imaging regions.

### DETAILED DESCRIPTION

Hereinafter, an embodiment of the present disclosure will be described with reference to the drawings.

### First Embodiment

### Configuration of Entire Three-dimensional Measuring Apparatus 100 and Configuration of Each Unit

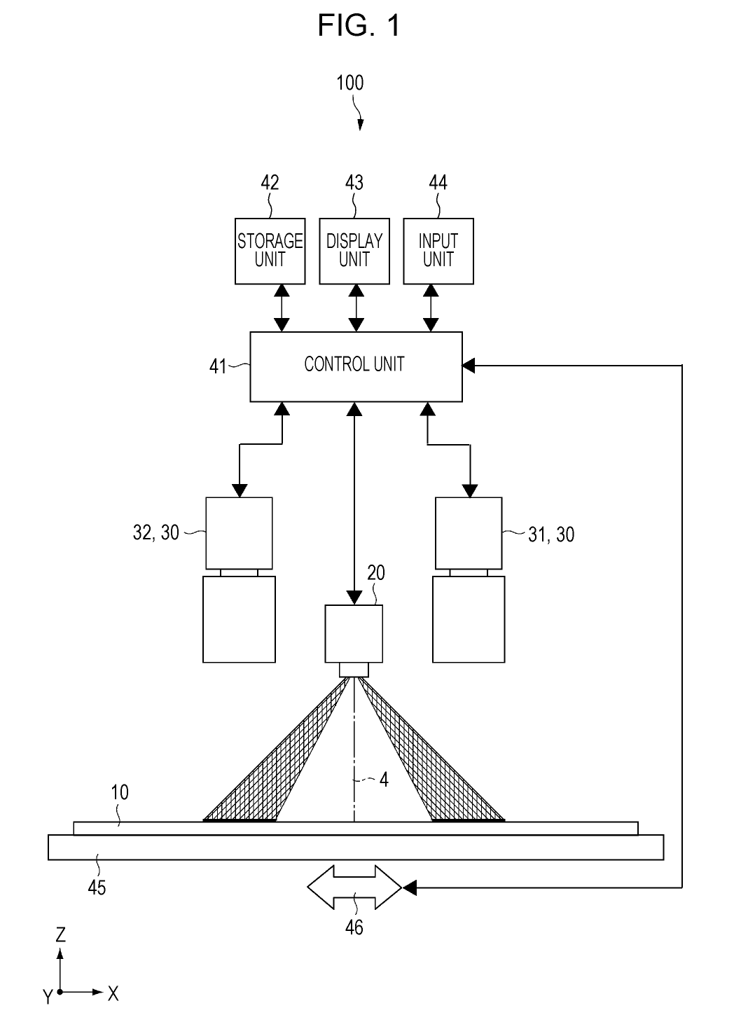

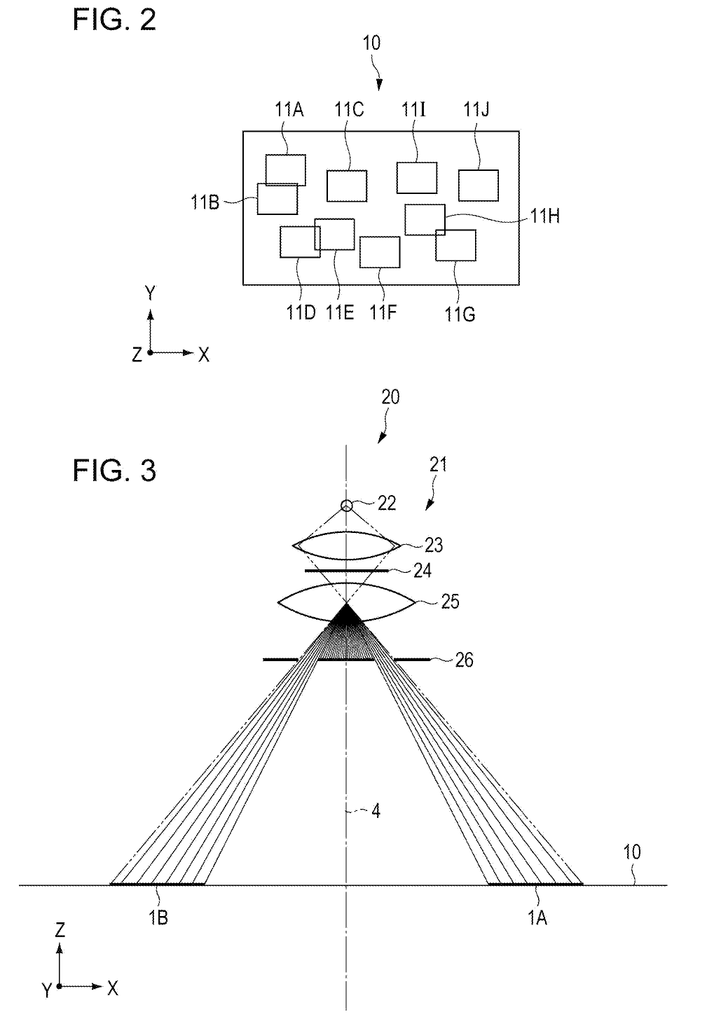

FIG. 1 is a diagram illustrating a three-dimensional measuring apparatus 100 according to a first embodiment of the present disclosure. FIG. 2 is a diagram illustrating an example of a measurement object 10 to be three-dimensionally measured by three-dimensional measuring apparatus 100.

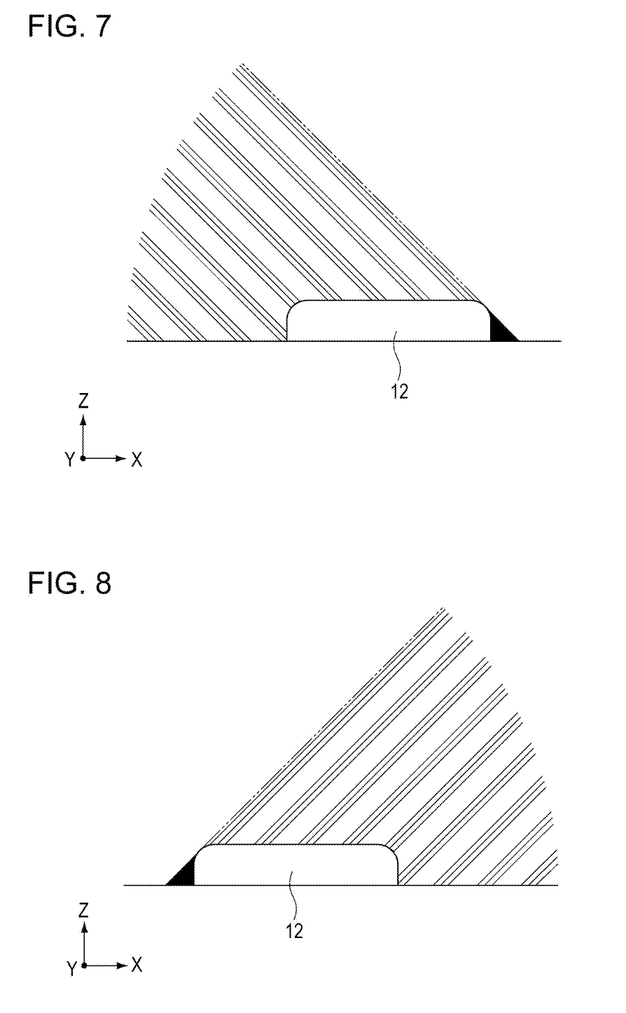

As shown in FIG. 2, according to this embodiment, an example of a substrate 10 having a plurality of inspection regions 11 (11A to 11J) will be described as an example of a measurement object 10 to be three-dimensionally measured by the three-dimensional measuring apparatus 100. At the inspection regions 11, for example, solders are printed as inspection objects 12 (see FIGS. 7 and 8 and the like). In the example shown in FIG. 2, the substrate 10 has ten inspection regions 11.

As shown in FIG. 1, the three-dimensional measuring apparatus 100 includes a stage 45 on which a substrate 10 is placed, a stage moving mechanism 46 (moving unit), a projecting unit 20, an imaging unit 30, a control unit 41, a storage unit 42, a display unit 43, and an input unit 44.

The projecting unit 20 is configured by, for example, a projector. The projecting unit 20 is disposed such that an optical axis 4 is perpendicular to the surface (projection surface) of the substrate 10.

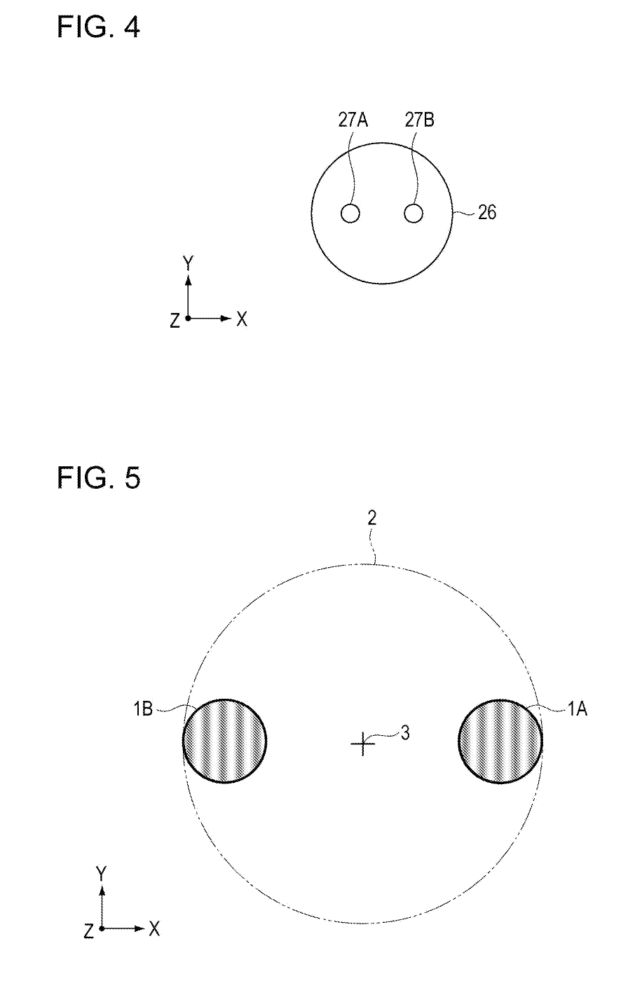

FIG. 3 is a diagram illustrating an optical system 21 of the projecting unit 20. FIG. 4 is a plan view illustrating a light-shielding mask 26. FIG. 5 is a plan view illustrating the shape of a stripe projected to the substrate 10 and illustrating a relationship between a projectable region 2 and imaging regions 1.

As shown in FIG. 3, the projecting unit 20 includes the optical system 21. The optical system 21 includes a light source 22, a condensing lens 23 that condenses light from the light source 22, a phase grating 24 that passes through the light condensed by the condensing lens 23 to form a stripe, and a projecting lens 25 that projects the light passing through the phase grating 24 to the surface of the substrate 10. The optical system 21 is configured such that the optical axis 4 of the entire optical system 21 is perpendicular to the surface of the substrate 10.

Examples of the light source 22 include a halogen lamp, a xenon lamp, a mercury lamp, and an LED (Light Emitting Diode), but the kinds of light source 22 is not particularly limited. The phase grating 24 includes a plurality of slits. The phase grating 24 forms a stripe of which luminance is varied sinusoidally by the plurality of slits and projects the stripe to the surface of the substrate 10.

The phase grating 24 is provided with a grating moving mechanism (not shown) that moves the phase grating 24 in a direction (X axis direction) perpendicular to a direction in which the slits are formed. The grating moving mechanism moves the phase grating 24 under the control of the control unit 41 and shifts the phase of the stripe projected to the substrate 10. A liquid crystal grating or the like that displays a grating-shaped stripe may be used instead of the phase grating 24 and the grating moving mechanism.

Referring to FIGS. 3 to 5, when a vertical line is drawn from the projecting unit 20 to the substrate 10, the projecting unit 20 can project the stripe to the peripheral region of an intersection point 3 between the vertical line and the surface (projection surface) of the substrate 10. Further, a region which is the peripheral region of the intersection point 3 between the vertical line and the surface (projection surface) of the substrate 10 and to which the stripe can be projected is referred to as the projectable region 2. In this embodiment, as described above, the vertical line oriented from the projecting unit 20 to the substrate 10 is identical with the optical axis since the optical axis 4 is perpendicular to the surface of the substrate 10. Accordingly, in this embodiment, the peripheral region of the intersection point 3 between the optical axis and the surface (projection surface) of the substrate becomes the projectable region 2. Here, since the optical axis 4 of the projecting unit 20 is perpendicular to the surface of the substrate 10, the projecting unit 20 can project the stripe with a uniform width without distortion of an image to the entire projectable region 2. When the optical axis 4 is inclined with respect to the surface of the substrate, the stripe image may be distorted in some cases.

A plurality of imaging regions 1 (1A and 1B) are disposed in the projectable region 2. The inspection regions 11 to which the stripe is projected are imaged at the imaging regions 1. Since the projectable region 2 is configured as a broad region centered at the intersection point 3, the plurality of imaging regions 1 can be provided within the projectable region 2. Further, since the projecting unit 20 can project the stripe with the uniform width without the distortion of an image to the entire projectable region 2, the imaging regions 1 can be disposed at any position within the projectable region 2.

The number of imaging regions 1 or the positions of the imaging regions 1 in the projectable region 2 may be arbitrarily set in order to exclude the influence of a shadow, exclude the influence of halation, and improve an inspection speed.

In this embodiment, a case will be described in which the plurality of imaging regions 1 are disposed in the projectable region 2, for example, in order to exclude the influence of a shadow. The number of imaging regions 1 is two. In this embodiment, in order to facilitate the understanding, two imaging regions, that is, a first imaging region 1A and a second imaging region 1B are disposed. The first imaging region 1A and the second imaging region 1B are disposed at the positions opposite (180°) to each other with reference to the intersection point 3. The relative positions of the imaging regions 1 in the projectable region 2 will be described in detail later.

Referring to FIGS. 3 and 4, the light-shielding mask 26 is formed below the projecting lens 25. Here, when the stripe is projected in a region other than the first imaging region 1A and the second imaging region 1B in the projectable region 2, diffused reflection occurs, and thus the diffusely reflected stripe is incident on the imaging unit 30. Therefore, there is a concern that the measurement accuracy of the inspection object 12 may deteriorate.

Accordingly, in this embodiment, the light-shielding mask 26 that restricts the projection of the stripe is provided in order to prevent the stripe from being projected to a region other than the first imaging region 1A and the second imaging region 1B in the projectable region 2. The light-shielding mask 26 is formed, for example, by forming openings 27 (27A and 27B) in a circular thin plate member. The openings 27A and 27B are disposed at the positions corresponding to the positions of the first imaging region 1A and the second imaging region 1B disposed in the projectable region 2.

As shown in FIG. 5, the light-shielding mask 26 can prevent the stripe from being projected to a region other than the first imaging region 1A and the second imaging region 1B. Thus, it is possible to prevent the measurement accuracy of the inspection object 12 as a solder from deteriorating due to the diffused reflection of the stripe incident on the imaging unit 30.

In FIG. 3, the light-shielding mask 26 is disposed below the projecting lens 25. However, the light-shielding mask 26 may be disposed between the light source 22 and the condensing lens 23, between the condensing lens 23 and the phase grating 24, or between the phase grating 24 and the projecting lens 25.

Referring back to FIG. 1, the imaging unit 30 includes a first imaging section 31 and a second imaging section 32 corresponding to the first imaging region 1A and the second imaging region 1B, respectively. The first imaging section 31 and the second imaging section 32 each include an imaging element such as a CCD (Charge Coupled Device) sensor or a CMOS (Complementary Metal Oxide Semiconductor) sensor. The first imaging section 31 and the second imaging section 32 each include an optical system such as an image forming lens that forms an image on the imaging surface of the imaging element with the light from the imaging region 1. The first imaging section 31 and the second imaging section 32 image the inspection regions 11 on the substrate 10 to which the stripe is projected under the control of the control unit 41.

The stage 45 is configured to hold the substrate 10. The stage moving mechanism 46 moves the stage 45 in XY directions in response to a driving signal from the control unit 41. The stage moving mechanism 46 varies the relative position of the inspection region 11 of the substrate 10 with respect to the imaging region 1 by moving the stage 45 in the XY directions.

The display unit 43 is configured by, for example, a liquid crystal display. The display unit 43 displays the three-dimensional image of the inspection region 11 on the substrate 10 under the control of the control unit 41. The input unit 44 is configured by a keyboard, a mouse, a touch panel, or the like. The input unit 44 inputs an instruction from a user.

The storage unit 42 includes a non-volatile memory such as a ROM (Read Only Memory) storing various kinds of programs necessary for the process of the three-dimensional measuring apparatus 100 and a volatile memory such as a RAM (Random Access Memory) used as a working area of the control unit 41.

The control unit 41 is configured by, for example, a CPU (Central Processing Unit). The control unit 41 controls the three-dimensional measuring apparatus 100 on the whole based on the various kinds of programs stored in the storage unit 42. For example, the control unit 41 controls the stage moving mechanism 46 such that the stage moving mechanism 46 varies the relative position of the inspection region 11 with respect to the imaging region 1 to match the inspection region 11 and the position of the imaging region 1. The control unit 41 controls the grating moving mechanism such that the grating moving mechanism shifts the phase of the stripe projected to the substrate 10. Further, the control unit 41 controls the imaging unit 30 such that the imaging unit 30 captures the image of the inspection region 11 to which the stripe is projected or calculates the three-dimensional shape of the inspection region 11 by a phase shift method based on the captured image.

### Description of Process

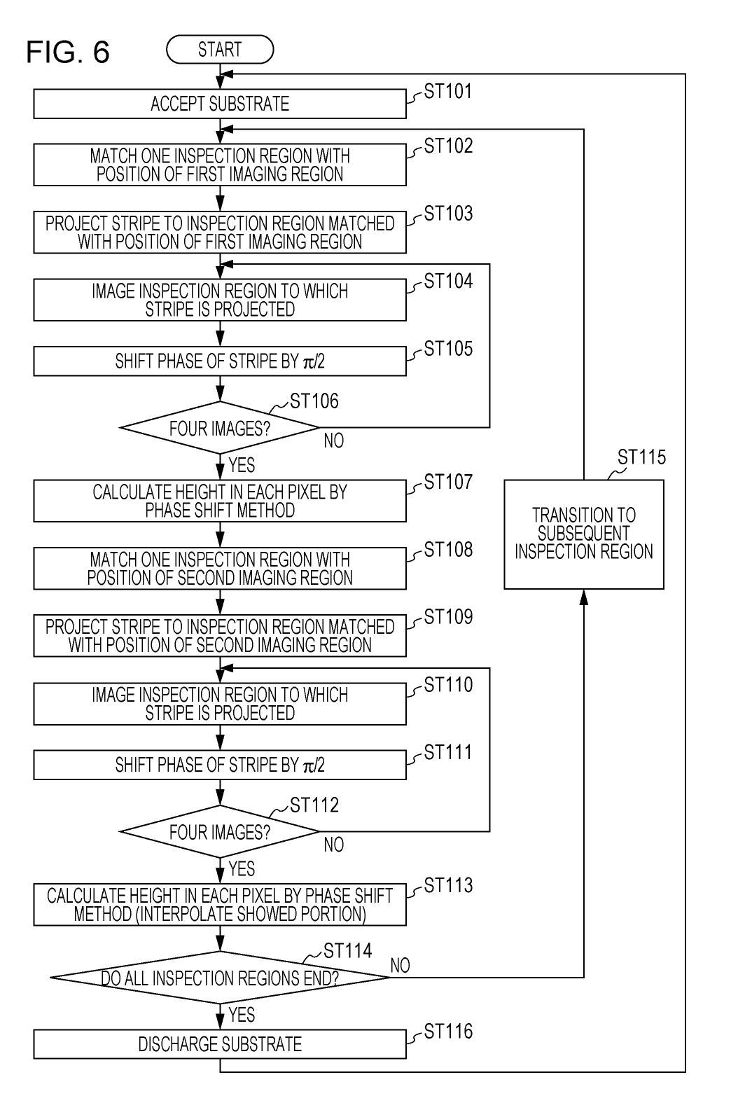

FIG. 6 is a flowchart illustrating the process of the control unit 41 of the three-dimensional measuring apparatus 100.

First, the control unit 41 of the three-dimensional measuring apparatus 100 controls the stage moving mechanism 46 such that the stage moving mechanism 46 moves the stage 45 up to the acceptance position of the substrate 10. The stage moving mechanism 46 accepts the substrate 10 from a substrate delivering device (not shown) (ST 101).

Next, the control unit 41 controls the stage moving mechanism 46 such that the stage moving mechanism 46 moves the stage 45 and matches one inspection region 11 among the plurality of inspection regions 11 with the position of the first imaging region 1A (ST 102). In this case, the inspection region 11A located in the left upper portion in FIG. 2 among the plurality of inspection regions 11 is matched with the position of the first imaging region 1A. Next, the control unit 41 emits light from the projecting unit 20 such that the projecting unit 20 projects the stripe to the inspection region 11 matched with the position of the first imaging region 1A (ST 103).

FIG. 7 is a diagram illustrating the shape of a shadow formed by the inspection object 12 such as a solder formed in the inspection region 11 when the inspection region 11 is located at the first imaging region 1A. When the inspection region 11 is located at the first imaging region 1A, as shown in FIG. 7, the shadow is formed on the right side of the inspection object 12.

When the stripe is projected, the control unit 41 allows the first imaging section 31 to image the inspection region 11, to which the stripe is projected, at the first imaging region 1A (ST 104). Next, the control unit 41 controls the grating moving mechanism such that the gating moving mechanism moves the phase grating 24 in order to shift the phase of the stripe projected to the inspected region 11 by π/2 [rad] (ST 105). When the control unit 41 shifts the phase of the stripe, the control unit 41 subsequently determines whether four images are captured (ST 106).

When four images are not captured (NO in ST 106), the process returns to ST 104 and the control unit 41 images the inspection region 11 to which the stripe is projected. Then, the control unit 41 again shifts the phase of the stripe by π/2 [rad] (ST 105) and again determines whether four images are captured (ST 106). In this way, a total of four images for which the phases of the stripe are different from each other are captured.

When the four images are captured (YES in ST 106), the control unit 41 calculates the height of each pixel of the image based on the four images by the phase shift method (ST 107). In this case, the control unit 41 extracts the luminance value of each pixel (coordinates (x, y)) from the four images and calculates the phase φ (x, y) of each pixel by applying Equation (1) below. Then, the control unit 41 calculates the height of each pixel by the triangulation principle based on the calculated phase φ(x, y) of each pixel.

In Equation (1), I₀(x, y), I_{π/2}(x, y), I_{π}(x, y), and I_{3π/2}(x, y) are the luminance values of the pixels (coordinates), respectively, when the phases are 0, π/2, π, and 3π/2.

φ(x, y)=Tan⁻¹ {I_{3π/2}(x, y)−I_{π/2}(x,y)/{I₀(x, y)−I_{π}(x, y)} (1)

As shown in FIG. 7, the luminance of a portion shadowed by the inspection object 12 such as a solder is zero. Therefore, since there is no difference in the luminance value between the respective images in the pixel (coordinates), the phase φ can be calculated by Equation (1) above. Therefore, the control unit 41 may not calculate the height of each pixel in the shadowed portion.

When the height of each pixel is calculated, the control unit 41 subsequently controls the stage moving mechanism 46 such that the stage moving mechanism 46 varies the relative positions of the inspection regions 11 with respect to the imaging regions 1A and 1B. Then, the control unit 41 matches the inspection region 11 imaged immediately prior to the first imaging region 1A to the position of the second imaging region 1B (ST 108). When the inspection region 11 is matched with the position of the second imaging region 1B, the stripe is projected to the inspection region 11 (ST 109).

FIG. 8 is a diagram illustrating the shape of a shadow formed by the inspection object 12 when the inspection region 11 is located at the second imaging region 1B. When the inspection region 11 is located at the second imaging region 1B, as shown in FIG. 8, a shadow is formed on the left side of the inspection object 12 such as a solder. However, the stripe can be projected to the right side of the inspection object 12 on which the shadow has been formed in FIG. 7.

When the stripe is projected, the control unit 41 allows the second imaging section 32 to image the inspection region 11 to which the stripe is projected (ST 110). Next, the control unit 41 controls the grating moving mechanism such that the gating moving mechanism moves the phase grating 24 in order to shift the phase of the stripe projected to the inspected region 11 by π/2 [rad] in the second imaging region 1B (ST 111). Next, the control unit 41 determines whether four images are captured (ST 112).

When a total of four images for which the phases of the stripe are different from each other are captured (YES in ST 112), the control unit 41 calculates the height of each pixel of the image based on the four images by the phase shift method (ST 113). In this case, the control unit 41 calculates the height of each pixel (coordinates) by the phase shift method using Equation (1) above.

Here, when the inspection region 11 is located at the second imaging region 1B, the shadowed portion formed when the inspection region 11 is located at the first imaging region 1A is not shadowed (see FIGS. 7 and 8). Accordingly, in ST 108, the control unit 41 can interpolate the pixel (coordinates) of which the height may not have been calculated due to the shadow in ST 107. In this way, the control unit 41 can accurately calculate the shape of the inspection object 12 in the inspection region 11. That is, the influence of the shadow can be excluded by imaging one inspection region 11 at the plurality of imaging regions 1 and calculating the three-dimensional shape of the inspection object 12. Accordingly, the shape of the inspection object 12 can accurately be calculated.

When the three-dimensional shape of the inspection region 11 is calculated, the control unit 41 displays the three-dimensional shape of the inspection region 11 on the display unit 43. The user views the three-dimensional image and inspects the inspection object 12 formed in the inspection region 11 of the substrate 10. Since the image displayed on the display unit 43 is an image accurately formed by excluding the influence of the shadow, a minute defect of the inspection object 12 can accurately be determined.

Next, the control unit 41 determines whether the calculation of the three-dimensional shape of the inspection region 11 by the phase shift method ends for all of the inspection regions 11 (ST 114). When the calculation of the three-dimensional shape does not end for all of the inspection regions 11 (NO in ST 114), the control unit 41 transitions to the calculation of the three-dimensional shape of the subsequent inspection region 11 (ST 115) and matches the subsequent inspection region 11 with the position of the first imaging region 1A (ST 101). Then, the processes of ST 101 to ST 114 are repeated. The sequence of the calculation of the three-dimensional shapes of the inspection regions 11 is not particularly limited. For example, the three-dimensional shape is calculated in the sequence of the inspection regions 11A, 11B, 11C, . . . , and 11J.

When the calculation of the three-dimensional shape ends for all of the inspection regions 11 of the substrate 10 (YES in ST 114), the control unit 41 controls the stage moving mechanism 46 such that the stage moving mechanism 46 moves the substrate 10 up to a discharging position and discharges the substrate 10 (ST 116). Then, the control unit 41 accepts a new substrate 10 from the substrate delivering device and executes the processes of ST 101 to ST 116.

As described with reference to FIG. 6, one inspection region 11 is imaged at the imaging regions 1, that is, both the first imaging region 1A and the second imaging region 1B, and then the subsequent inspection region 11 is imaged. However, all of the inspection regions 11 may be imaged at the first imaging region 1A, and then all of the inspection regions 11 may be imaged at the second imaging region 1B.

### Positions of Plurality of Imaging Regions 1 for Excluding Influence of Shadow

Next, the positions of the plurality of imaging regions 1 in the projectable region 2 for excluding the influence of a shadow will be described.

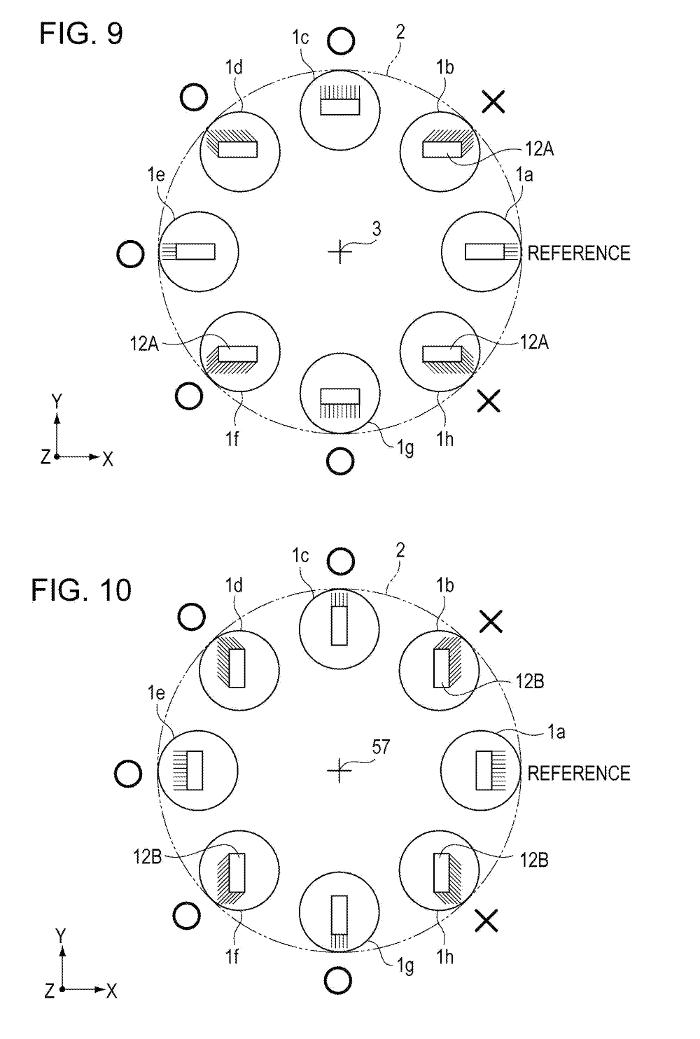

FIGS. 9 to 12 are diagrams illustrating the positions of the plurality of imaging regions 1 for excluding the influence of a shadow and illustrating the shapes of shadows formed when inspection objects 12 (12A to 12D) are located at imaging regions 1 (1a to 1h). FIGS. 9 to 12 shows the shapes of the shadows when the inspection objects 12 are located at the inspection regions 11 on the substrate 10 in the lateral direction (0°), the longitudinal direction (90°), the direction of +45°, and the direction of −45°.

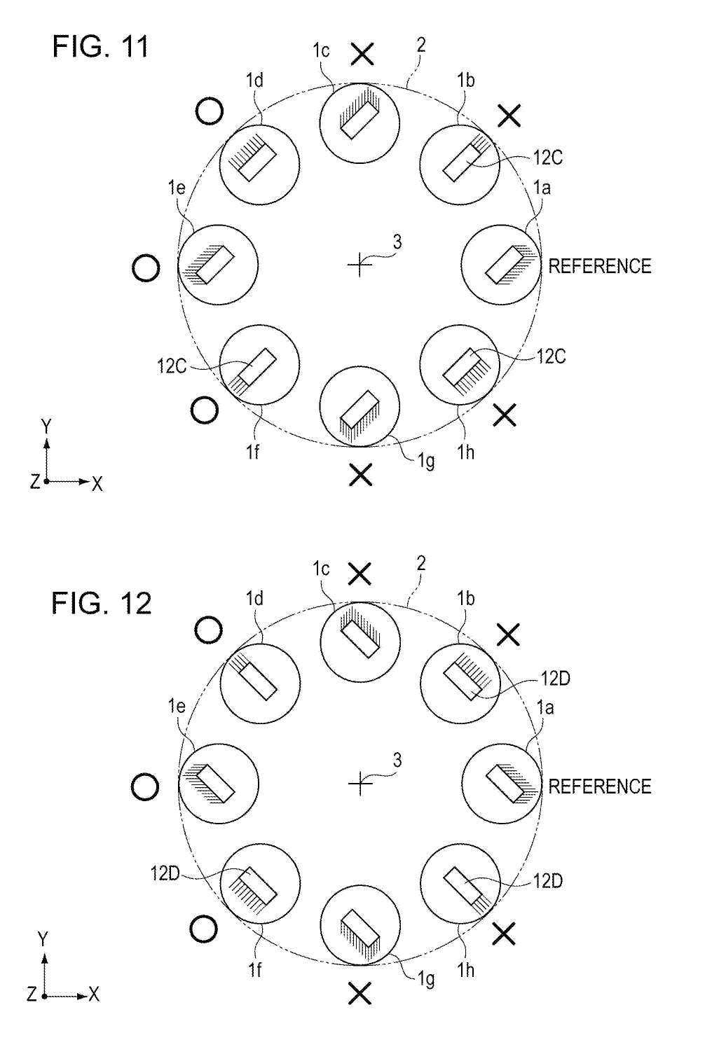

As shown in FIGS. 9 to 12, the inspection objects 12 (12A to 12D) such as solders formed at the inspection regions 11 on the substrate 10 generally have a rectangular parallelepiped longitudinal in one direction in many cases. In this case, as shown in FIGS. 9 and 10, the inspection objects 12 (12A and 12B) are most commonly formed in the lateral direction (0°) (X axis direction) or the longitudinal direction (90°) (Y axis direction) on the substrate 10. The inspection objects 12 are most commonly formed in the lateral or longitudinal direction and, as shown in FIGS. 11 and 12, the inspection objects 12 (12C and 12D) are second most commonly formed in the directions of ±45°.

The relative position of two imaging regions 1 in the projectable region 2 will be described with reference to FIGS. 9 to 12. Here, it is assumed that one imaging region 1 of the two imaging regions 1 is disposed at the position (reference position) of the imaging region 1a. An appropriate relative position of the other imaging region 1 with respect to the one imaging region 1 will be described. The description will be made on the assumption that the position of the imaging region 1a is 0° in the projectable region 2.

First, referring to FIGS. 9 and 10, a case will be described in which the inspection objects 12 (12A and 12B) are formed in the lateral or longitudinal direction in the inspection regions 11. In this case, when the inspection object 12 is located at the imaging region 1a, a shadow is formed on the right side of the inspection object 12.

At the imaging regions 1b and 1h located at the positions of the angles of ±45° with respect to the imaging region 1a, a shadow is formed in the portion in which the shadow is formed when the inspection object 12 is located at the imaging region 1a. However, at the imaging regions 1c, 1g, 1d, 1f, and 1c located at the positions of the angles of ±90°, ±135°, and 180° with respect to the imaging region 1a, a shadow is not formed in the portion in which the shadow is formed when the inspection object 12 is located at the first imaging region 1a.

That is, when the inspection object 12 is formed in the lateral or longitudinal direction, the influence of the shadow can appropriately be excluded as long as the other imaging region 1 falls within a range of 180°±90° with respect to the one imaging region 1.

Next, referring to FIGS. 11 and 12, a case will be described in which the inspection objects 12 (12C and 12D) are formed in the direction of +45° or −45° in the inspection regions 11. In this case, when the inspection object 12 is located at the imaging region 1a, a shadow is formed on the right side of the inspection object 12.

At the imaging regions 1b, 1h, 1c, and 1g located at the positions of the angles of ±45° and ±90° with respect to the imaging region 1a, a shadow is formed in the portion in which the shadow is formed when the inspection object 12 is located at the imaging region 1a. However, at the imaging regions 1d, 1f, and 1e located at the positions of the angles of ±135° and 180° with respect to the imaging region 1a, a shadow is not formed in the portion in which the shadow is formed when the inspection object 12 is located at the imaging region 1a.

That is, when the inspection object 12 is formed in the direction of +45° or −45° on the substrate 10, the influence of the shadow can appropriately be excluded as long as the other imaging region 1 falls within a range of 180°±45° with respect to the one imaging region 1.

Further, even when the inspection object 12 is formed in any direction of the lateral direction, the longitudinal direction, the direction of +45°, and the direction of −45°, the influence of the shadow can appropriately be excluded as long as the other imaging region 1 falls within the range of 180°±45° with respect to the one imaging region 1.

As described above with reference to FIGS. 9 and 10, one inspection object 12 is disposed at one inspection region 11 in order to facilitate the understanding. However, the plurality of inspection objects 12 in different directions are formed in one inspection region 11 in some cases. For example, the inspection objects 12A, 12B, 12C, and 12D in the lateral direction, the longitudinal direction, the direction of +45°, and the direction of −45° are formed in one inspection region 11 in some cases. Even in the cases, the influence of the shadow can appropriately be excluded as long as the other imaging region 1 falls within the range of 180°±45° with respect to the one imaging region 1.

### Second Embodiment

Next, a second embodiment of the present disclosure will be described. When the second embodiment is described, the same reference numerals are given to the constituent elements having the same configuration and function as those of the above-described first embodiment and the description thereof will not be repeated or simplified.

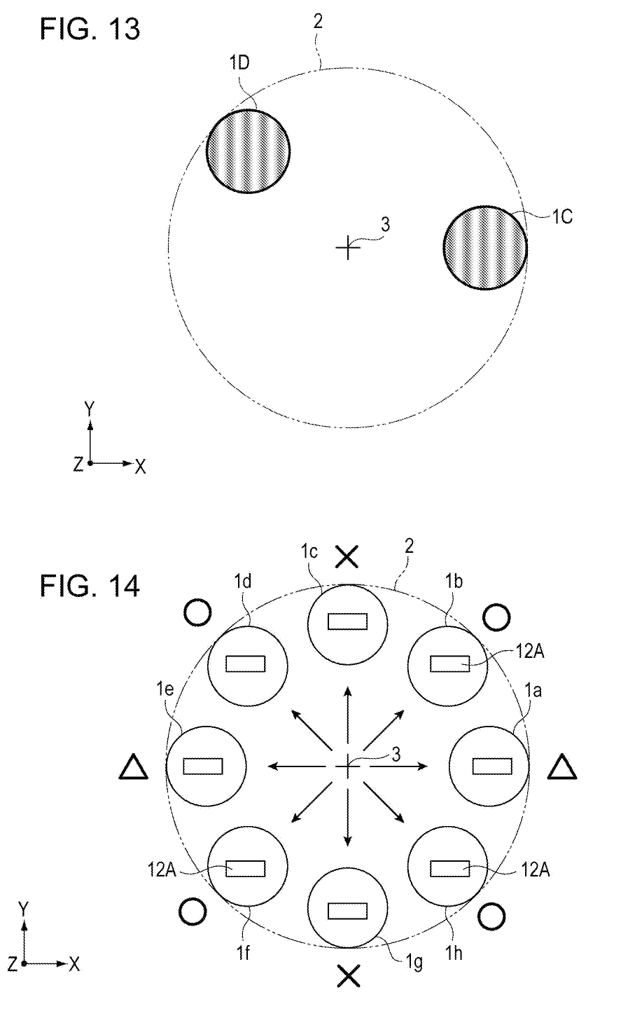

FIG. 13 is a diagram illustrating the plurality of imaging regions 1 disposed in the projectable region 2 according to the second embodiment. In the example shown in FIG. 13, a first imaging region 1C is disposed at the position of 0° and a second imaging region 1D is disposed at the position of 135° in the projectable region 2.

In the second embodiment, since the position of the second imaging region 1D is different from that of the first embodiment, the position of the imaging unit 30 (second imaging section 32) or the position of the opening 27 of the light-shielding mask 26 are appropriately modified so as to be suitable for the position of the second imaging region 1D.

The first imaging region 1C and the second imaging region 1D are disposed at these positions in order to exclude the influence of halation. Hereinafter, the positions of the first imaging region 1C and the second imaging region 1D will be described.

FIGS. 14 to 17 are diagrams illustrating the positions of the plurality of imaging regions 1 for excluding the influence of halation and illustrating the influence of halation formed when inspection objects 12 (12A to 12D) are located at imaging regions 1 (1a to 1h). FIGS. 14 to 17 show the influence of halation when the inspection objects 12 are located in the inspection regions 11 in the lateral direction) (0°), the longitudinal direction (90°), the direction of +45°, and the direction of −45°.

When light is emitted vertically to the long side of the inspection object 12 such as a solder, halation may occur in some cases. Accordingly, in FIGS. 14 to 17, a mark×is given when the light is emitted vertically to the long side of the inspection object 12. When the light is emitted vertically to the short side of the inspection object 12, halation may also occur in some cases. There is a low possibility that the halation occurs where the light is emitted vertically to the short side of the inspection object 12, compared to the case where the light is emitted vertically to the long side of the inspection object 12. In this case, a mark Δ is given in the drawing. Since there is a low possibility that the halation occurs in other cases, a mark ∘ is given in the drawing.

First, the case where the inspection object 12A is disposed in the lateral direction, as shown in FIG. 14, will be described. In this case, when the inspection object 12A is located at the imaging regions 1c and 1g of ±90°, the light is emitted vertically to the long side of the inspection object 12A. Therefore, the halation may occur in some cases (see the mark ×). When the inspection object 12A is located at the imaging regions 1a and 1e of 0° and 180°, the light is emitted vertically to the short side of the inspection object 12A. Therefore, the halation may occur in some cases (see the mark Δ). However, when the inspection object 12A is located at the imaging regions 1b, 1h, 1d, and 1f of ±45° and ±135°, the light is not emitted to the long side and the short side of the inspection object 12. In this case, there is a low possibility that the halation occurs (see the mark ∘).

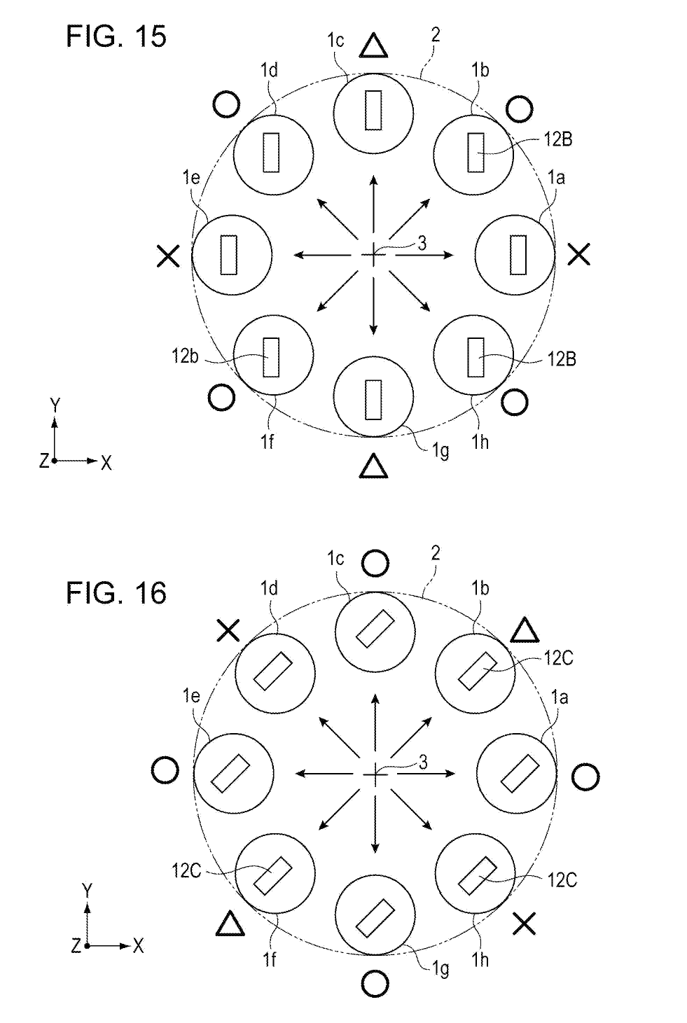

When the inspection object 12B is disposed in the longitudinal direction, as shown in FIG. 15, the light is emitted vertically to the long side of the inspection object 12B at the imaging regions 1a and 1e of 0° and 180° (see the mark ×). The light is emitted vertically to the short side of the inspection object 12B at the imaging regions 1c and 1g of ±90° (see the mark Δ). However, the light is not emitted to the long side and the short side of the inspection object 12 at the imaging regions 1b, 1h, 1d, and 1f of ±45° and ±135° (see the mark ∘).

It can be understood that at least one imaging region 1 among the plurality of imaging regions 1 is disposed at a position deviated from 0°, ±90°, and 180° in the projectable region 2 in order to prevent the light from being vertically incident on the sides of the inspection objects 12A and 12B disposed in the lateral direction or the longitudinal direction. From this viewpoint, the second imaging region 1D is disposed at the position of 135° in the projectable region 2, as shown in FIG. 13.

When an inspection object 12C is disposed in the direction of +45°, as shown in FIG. 16, the light is emitted vertically to the long side of the inspection object 12 at the imaging regions 1h and 1d of −45° and 135° (see the mark ×). The light is emitted vertically to the short side of the inspection object 12 at the imaging regions 1b and 1f of 45° and −135° (see the mark Δ). However, the light is not emitted vertically to the long side and the short side of the inspection object 12C at the imaging regions 1a, 1c, 1g, and 1e of 0°, ±90°, and 180° (see the mark ∘).

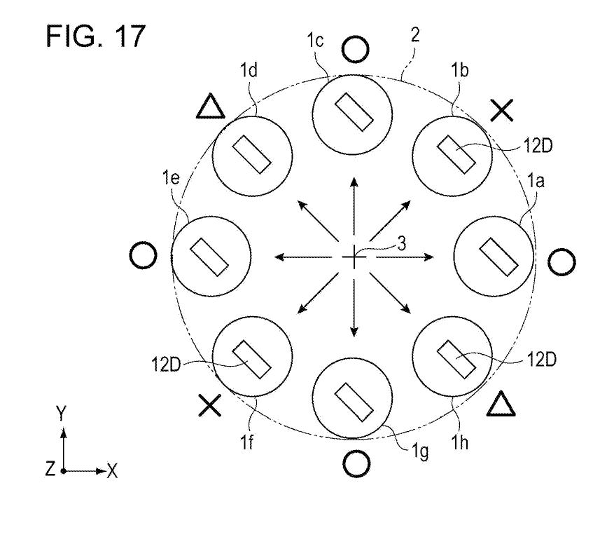

When an inspection object 12D is disposed in the direction of −45°, as shown in FIG. 17, the light is emitted vertically to the long side of the inspection object 12 at the imaging regions 1b and 1f of 45° and −135° (see the mark ×). The light is emitted vertically to the short side of the inspection object 12 at the imaging regions 1h and 1d of −45° and 135° (see the mark Δ). However, the light is not emitted vertically to the long side and the short side of the inspection object 12 at the imaging regions 1a, 1c, 1g, and 1e of 0°, ±90°, and 180° (see the mark ∘).

It can be understood that at least one imaging region 1 among the plurality of imaging regions 1 is disposed at a position deviated from ±45° and ±135° in the projectable region 2 in order to prevent the light from being vertically incident on the sides of the inspection objects 12C and 12D disposed in the directions of ±45°. From this viewpoint, the first imaging region 1C is disposed at the position of 0° in the projectable region 2, as shown in FIG. 13.

### Description of Process

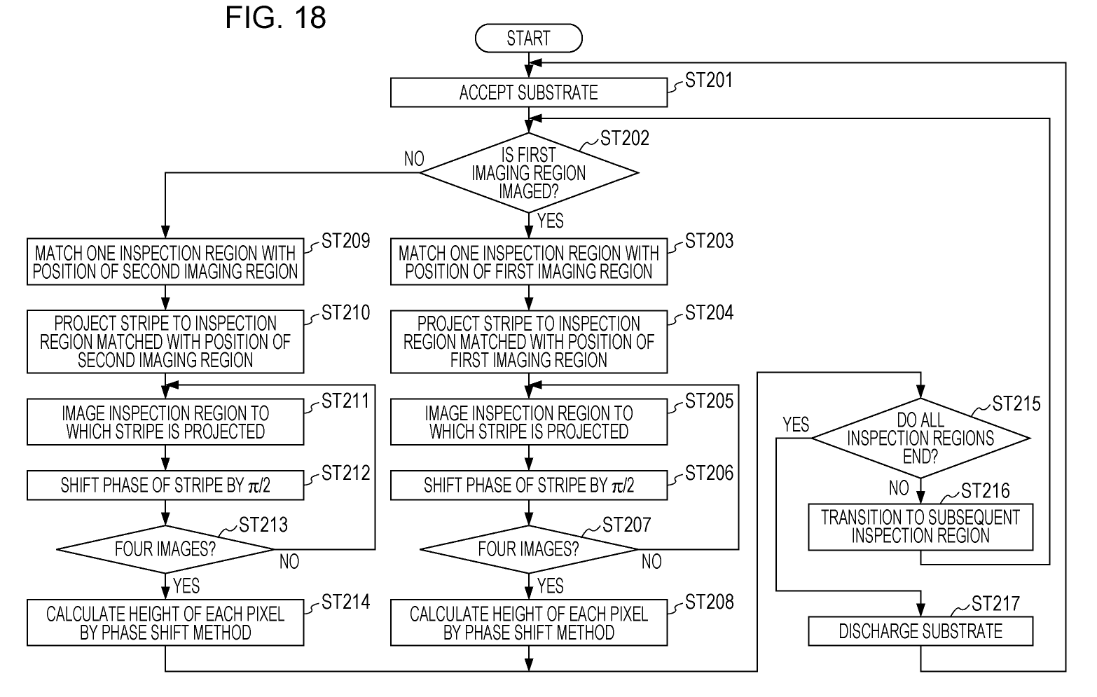

Next, a process of the three-dimensional measuring apparatus 100 according to the second embodiment will be described. FIG. 18 is a flowchart illustrating the process of the three-dimensional measuring apparatus 100 according to the second embodiment.

First, the control unit 41 of the three-dimensional measuring apparatus 100 accepts the substrate 10 from the substrate delivering device (ST 201) and determines whether the inspection region 11 is a region imaged at the first imaging region 1C (ST 202).

The user resets the inspection region 11 to be imaged at the first imaging region 1C and the inspection region 11 to be imaged at the second imaging region 1D among the plurality of inspection regions 11 (11A to 11J) of the substrate 10 with reference to FIG. 2 through the input unit 44. For example, it is assumed that the inspection objects 12C and 12D in the directions of +45° and −45° are formed at the inspection regions 11A to 11E among the plurality of inspection regions 11 and the inspection objects 12A and 12B in the lateral direction and the longitudinal direction are formed at the inspection regions 11F to 11J. In this case, the user sets the inspection regions such that the inspection regions 11A to 11E are imaged at the first imaging region 1C and the inspection regions 11F to 11J are imaged at the second imaging region 1D.

When the inspection region 11 is a region to be imaged at the first imaging region 1C (YES in ST 202), the control unit 41 matches the inspection region 11 with the position of the first imaging region 1C (ST 203). Next, the control unit 41 allows the projecting unit 20 to project the stripe to the inspection region 11 located at the first imaging region 1C (ST 204) and acquires four images for which the phases of the stripe are different from each other (ST 205 to ST 207).

Further, when the inspection object 12 is illuminated with the light (stripe), the light incident on the inspection object 12 is not input vertically to the side of the inspection object 12 (see FIGS. 16 and 17). Therefore, no halation occurs.

When the four images for which the phases of the stripe are different from each other (YES in ST 207), the control unit 41 calculates the height of each pixel (coordinates) of the inspection region 11 based on the four images by the phase shift method (ST 208).

When the determination is negative in ST 202 (NO in ST 202), that is, the inspection region 11 is a region to be imaged at the second imaging region 1D, the control unit 41 matches the inspection region 11 with the position of the second imaging region 1D (ST 209). Next, the control unit 41 projects the stripe to the inspection region 11 located at the second imaging region 1D (ST 210) and acquires four images for which the phases of the stripe are different from each other (ST 211 to ST 213).

Further, when the inspection object 12 is illuminated with the light (stripe), the light incident on the inspection object 12 is not input vertically to the side of the inspection object 12 (see FIGS. 14 and 15). Therefore, no halation occurs.

When the four images for which the phases of the stripe are different from each other (YES in ST 213), the control unit 41 calculates the height of each pixel (coordinates) of the inspection region 11 based on the four images by the phase shift method (ST 214).

When the control unit 41 calculates the height of each pixel of the inspection regions 11, the control unit 41 subsequently determines whether the calculation of the three-dimensional shape of the inspection region 11 ends for all of the inspection regions 11 (ST 215). When the calculation of the three-dimensional shape does not end for all of the inspection regions 11 (NO in ST 215), the control unit 41 transitions to the calculation of the three-dimensional shape of the subsequent inspection region 11 (ST 216) and repeats the processes of ST 201 to ST 215.

When the calculation of the three-dimensional shape ends for all of the inspection regions 11 on the substrate 10 (YES in ST 215), the control unit 41 moves the substrate 10 up the discharging position and the discharges the substrate 10 (ST 217). Then, the control unit 41 accepts a new substrate 10 from the substrate delivering device and executes the processes of ST 201 to ST 217. Through the above-described processes, the problem with the halation can be resolved irrespective of the direction of the inspection object 12.

### Modification of Second Embodiment

In the process shown in FIG. 18, the case has been described in which one inspection region 11 is located at one imaging region 1 of the first imaging region 1C and the second imaging region 1D and is imaged. On the other hand, as in the above-described first embodiment, one inspection region 11 is moved sequentially to the positions of the first imaging region 1C and the second imaging region 1D and the inspection region 11 may be imaged at the first imaging region 1C and the second imaging region 1D.

For example, it is supposed that the inspection object 12 is disposed in the longitudinal direction at the inspection region 11. In this case, for example, when the inspection region 11 is imaged at the first imaging region 1C, the light may be incident vertically to the long side of the inspection region 12. Therefore, halation may occur in some cases. However, when the inspection region 11 is imaged at the second imaging region 1D, the light is not vertically incident on the side of the inspection object 12. Therefore, the halation does not occur. The same is applied to a case where the inspection object 12 is formed in the lateral direction and the directions of ±45°. The halation may occur at one of the two imaging regions 1, but the halation does not occur at the other hand thereof. Accordingly, even when one inspection region 11 is imaged at the two imaging regions 1C and 1D, the problem with the halation can be resolved irrespective of the direction of the inspection object 12.

When one inspection region 11 is imaged at each of the two imaging regions 1C and 1D, the effect can particularly be achieved due to the fact that the user may not set the imaging region 1 at which the inspection region 11 is imaged. Further, when one inspection region 11 is imaged at each of the two imaging regions 1C and 1D, the problem with the halation can appropriately be resolved in a case where the plurality of inspection objects 12 of which the directions are different from each other are formed at one inspection region 11.

Further, when one inspection region 11 is imaged at the two imaging regions 1C and 1D, the problem with the shadow and the problem with the halation can be resolved simultaneously. That is, in the second embodiment, the second imaging region 1D is in the range of 180°±45° with respect to the first imaging region 1C (see FIGS. 9 to 12). Accordingly, the problem with the shadow and the problem with the halation can be resolved simultaneously, irrespective of the direction of the inspection object 12, by imaging one imaging region 1 at each of the two imaging regions 1C and 1D.

As describe above with reference to FIGS. 14 to 17, at least one imaging region 1 among the plurality of imaging regions 1 is disposed at a position deviated from 0°, ±90°, and 180° or ±45° and ±135° in the projectable region 2. However, at least one imaging region 1 among the plurality of imaging regions 1 may be disposed so as to be excluded from the positions of 0°, ±45°, ±90°, ±135°, and 180°.

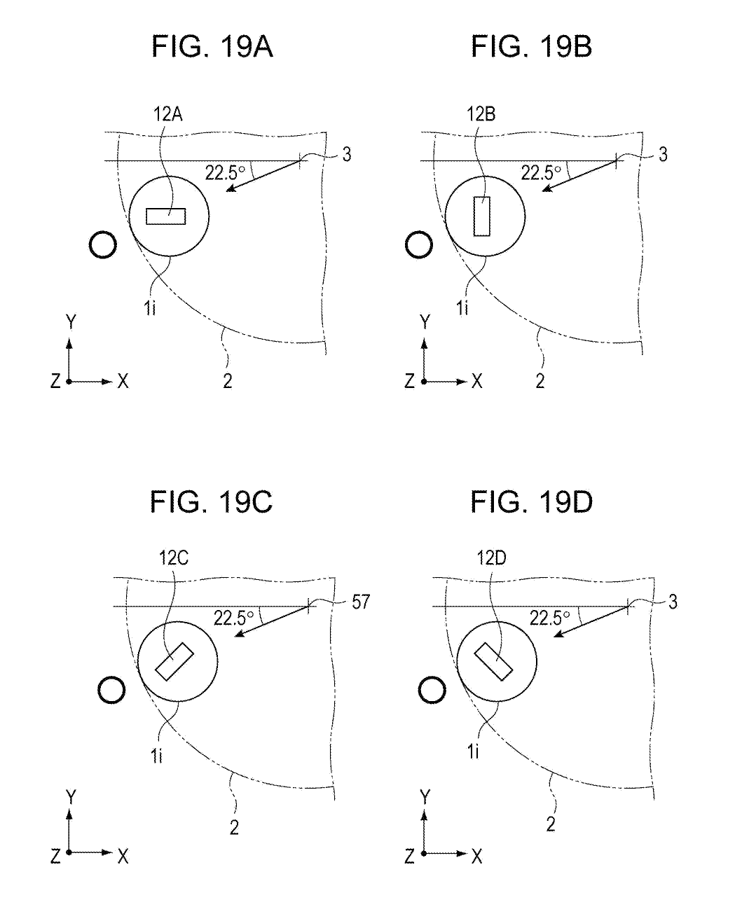

FIGS. 19A to 19D are diagrams illustrating the influence of the halation when the imaging region 1 is disposed at the position deviated from 0°, ±45°, ±90°, ±135°, and 180°. FIGS. 19A to 19D show the inspection object 12 formed in the lateral direction (0°), the longitudinal direction (90°), the direction of +45°, and the direction of −45°. Further, in FIGS. 19A to 19D, for example, the inspection region 11 is disposed at the position of 202.5°.

As shown in FIGS. 19A to 19D, when an imaging region 11i is disposed at the position deviated from 0°, ±45°, ±90°, ±135°, and 180°, the light (stripe) is not emitted vertically to the side of the inspection object 12 in any direction in which the inspection object 12 is formed. Accordingly, the halation can be prevented from occurring even when the inspection object 12 is formed in any direction.

### Third Embodiment

Next, a third embodiment of the present disclosure will be described. The third embodiment is different from the above-described embodiments in that a three-dimensional measuring apparatus 100 according to the third embodiment can switch between a high-accuracy mode (first mode) and a high-speed mode (second mode).

The high-accuracy mode is a mode in which one inspection region 11 is imaged at the plurality of imaging regions 1 by moving the one inspection region 11 to the positions of the plurality of imaging regions 1. The high-speed mode is a mode in which the plurality of imaging regions 1 are simultaneously imaged by simultaneously locating the plurality of inspection regions 11 to the plurality of imaging regions 1.

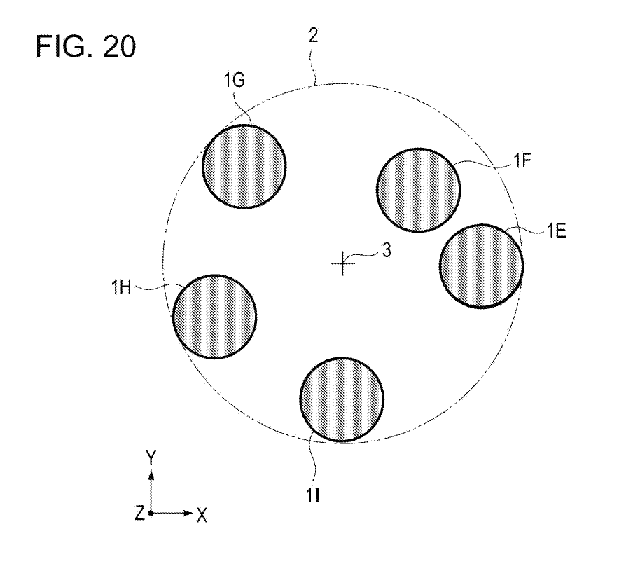

FIG. 20 is a diagram illustrating the disposition of the plurality of imaging regions 1 in the projectable region 2 according to the third embodiment. As shown in FIG. 20, in the third embodiment, five imaging regions 1E, 1F, 1G, 1H, and 1I are disposed in the projectable region 2. The five imaging regions 1E, 1F, 1G, 1H, and 1I are disposed at the positions of 0°, 45°, 135°, 202.5°, and 270°, respectively.

In the third embodiment, the imaging regions 1 disposed at the positions of 0°, 45°, 135°, 202.5°, and 270° are referred to the first imaging region 1E, the second imaging region 1F, the third imaging region 1G, the fourth imaging region 1H, and the fifth imaging region 1I, respectively.

In the third embodiment, since the number of imaging regions 1 is five, for example, the imaging unit 30 includes five imaging sections corresponding to the five imaging regions 1. Further, five openings 27 of the light-shielding mask 26 are formed at the positions corresponding to the positions of the five imaging regions 1 so as to correspond to the five imaging regions 1.

The five imaging regions 1 are disposed in the above-described manner in order to resolve the shadow or the problem with the halation. For example, in order to exclude the influence of the shadow, at least one imaging region 1 among the five imaging regions 1 is disposed in the range of 180°±90° (or 180°±45°) with respect to the other imaging regions 1 (see FIGS. 9 to 12). In order to exclude the influence of the halation, the second imaging region 1F and the third imaging region 1G are disposed at the positions deviated from 0°, ±90°, and 180° (see FIGS. 14 and 15). In order to exclude the influence of the halation, the first imaging region 1E and the fifth imaging region 1I are disposed at the positions deviated from ±45° and ±135° (see FIGS. 16 and 17). In order to exclude the influence of the halation, the fourth imaging region 1H is disposed at the position deviated from 0°, ±45°, ±90°, ±135°, and 180° (see FIGS. 19A to 19D).

The second imaging region 1F is different from the other imaging regions 1E, 1G, 1H, and 1I in the distance between the imaging region and the center (the intersection point 3 between the optical axis 4 and the surface of the substrate 10) of the projectable region 2. By disposing the imaging regions in this way, the measurement accuracy and the measurement range can be varied at the second imaging region 1F since the irradiation angle of the light emitted to the inspection object 12 is changed, compared to the other imaging regions 1E, 1G, 1H, and 1I. In general, the smaller the illumination angle of the light emitted to the inspection object 12 is, the better the resolving power(measurement accuracy) is. However, the measurement range is narrower. In contrast, in the phase shift method, the smaller the illumination angle of the light emitted to the inspection object 12 is, the poorer the resolving power is. However, the measurement range is wider.

### High Accuracy Mode

First, the high-accuracy mode will be described. In the high-accuracy mode, the same process as the process described above in the first embodiment is generally performed. For example, in the high-accuracy mode, the control unit 41 moves one inspection region 11 sequentially to the positions of the first imaging region 1E and the fourth imaging region 1H and images one inspection region 11 at each of the first imaging region 1E and the fourth imaging region 1H.

As combinations of the imaging regions 1, a combination of the first imaging region 1A and the fourth imaging region 1H, a combination of the first imaging region 1E and the third imaging region 1G, and a combination of the third imaging region 1G and the fifth imaging region 1I can be used. The present disclosure is not limited to the combinations. Of course, other combinations may be used. The number of imaging regions 1 to be used is not limited to two, but three or more imaging regions 1 may be used. In the high-accuracy mode, since the accurate three-dimensional image of the inspection object 12 can be displayed without the problem with the shadow or the problem with the halation, the user can accurately inspect the inspection regions 11.

### High-Speed Mode

Next, the high-speed mode will be described. The high-accuracy mode and the high-speed mode is switched in response to an instruction from the user through the input unit 44.

In the high-speed mode, the control unit 41 simultaneously moves the plurality of inspection regions 11 to the plurality of imaging regions 1 and simultaneously images the plurality of inspection regions 11 at the plurality of imaging regions 1. For example, it is assumed that the plurality of inspection regions 11 are disposed at the positions shown in FIG. 2 on the substrate 10. In this case, the control unit 41 simultaneously moves the inspection regions 11C and the inspection region 11A to the first imaging region 1E and the third imaging region 1G and simultaneously moves the two inspection regions 11C and 11A. Further, the control unit 41 simultaneously moves the inspection regions 11J, 11I, and 11H to the first imaging region 1E, the third imaging region 1G, and the fourth imaging region 1H and simultaneously image the three inspection regions 11J, 11I, and 11H.

The user sets the inspection regions 11 to be simultaneously imaged among the ten inspection regions 11 in advance in the three-dimensional measuring apparatus 100 through the input unit 44. The control unit 41 matches the other five inspection regions 11B and 11D to 11G to the positions of the fourth imaging region 1H and images the other five inspection regions 11B and 11D to 11G at the fourth imaging region 1H. In this example, since the two inspection regions 11C and 11A can simultaneously be imaged and the three inspection regions 11J, 11I, and 11H can simultaneously be imaged, the ten inspection regions 11 can be imaged by the seven imaging times (four images are acquired by one imaging time). In this way, in the high-speed mode, the inspection regions 11 can be imaged at high speed and the three-dimensional shape of the inspection object 12 can be calculated at high speed.

Here, the case has hitherto been described in which two or three inspection regions 11 are simultaneously imaged. However, four or more inspection regions 11 may be moved to the positions of four or more imaging regions 1 and may simultaneously be imaged.

In the three-dimensional measuring apparatus 100 according to the third embodiment, the user can arbitrarily switch between the high-accuracy mode and the high-speed mode. Thus, the user can select the high-accuracy mode and accurately display the three-dimensional image of the inspection object 12, when it is necessary to accurately inspect the inspection object 12. On the other hand, the user can select the high-speed mode and display the three-dimensional image of the inspection object 12 at high speed, when it is necessary to inspect the inspection object 12 at high speed.

In the third embodiment, the case has hitherto been described in which the three-dimensional measuring apparatus 100 has both the high-accuracy mode and the high-speed mode. However, it can be supposed that the three-dimensional measuring apparatus 100 has only the high-speed mode.

### Various Modifications

In the above-described embodiments, the stage moving mechanism 46 has hitherto been described as an example of a moving unit that moves the substrate 10 and the relative position of the plurality of imaging regions 1 in the XY directions. However, the moving unit may generally move the relative position of the substrate 10 with respect to the plurality of imaging regions 1 in the XY direction. For example, the moving unit may move the projecting unit 20 and the imaging unit 30 in the XY directions. Alternatively, the moving unit may move the stage 45 (substrate 10), the projecting unit 20, and the imaging unit 30 in the XY directions.

In the above-described embodiments, the imaging unit 30 includes the plurality of imaging sections corresponding to the plurality of imaging regions 1. However, the imaging unit 30 may include an imaging section capable of singly imaging two or more imaging regions 1.

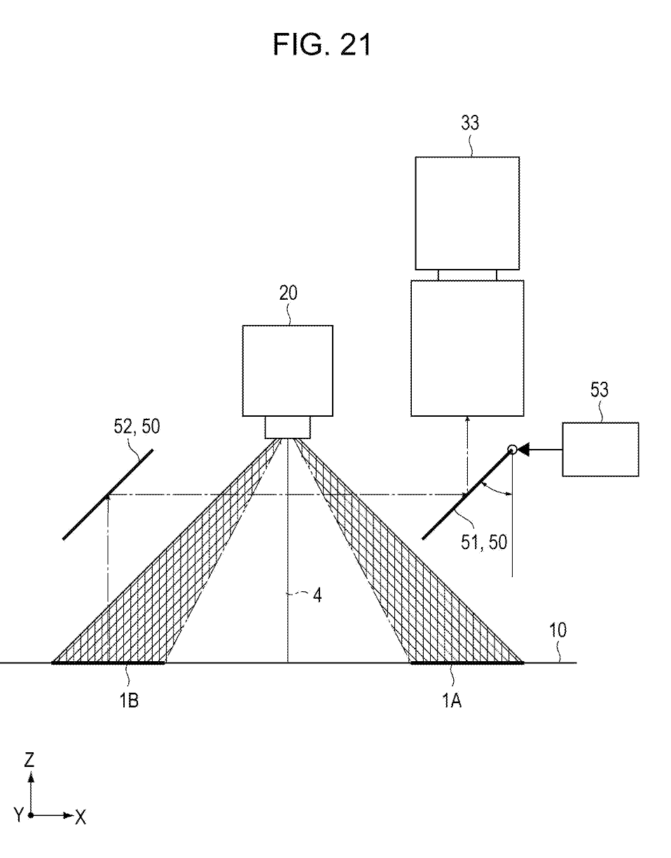

FIG. 21 is a diagram illustrating an example of an imaging section capable of singly imaging two or more imaging regions 1. Differences from the first embodiment will be mainly described with reference to FIG. 21.

In this example, as shown in FIG. 21, a reflection unit 50 is provided. The reflection unit 50 includes a first reflection section 51 installed below the imaging unit 33 (above the first imaging region 1A) and a second reflection section 52 installed above the second imaging region 1B.

The first reflection unit 51 is rotatable about the axis of the Y axis direction. The first reflection unit 51 is rotatable by driving of a driving unit 53 such as a motor. The driving unit 53 rotates the first reflection unit 51 under the control of the control unit 41 to switch between a first incident state in which the light from the first imaging region 1A is incident on the imaging section 33 and a second incident state in which the light from the second imaging region 1B is guided to the imaging section 33 by the reflection unit 50 and is incident on the imaging section 33.

The reflection unit 50 may be configured such that the light from the other imaging regions 1 can be incident on the imaging section 33, when there are the imaging regions 1 other than the first imaging region 1A and the second imaging region 1B. In the example shown in FIG. 21, the cost can be reduced since the number of imaging sections 33 can be reduced.

Alternatively, an imaging section that is capable of moves the relative position to the projecting unit 20 in the XY directions can be used as another example of the imaging section that is capable of singly imaging two or more imaging regions 1. The imaging section is rotatable about the projecting unit 20 and around the imaging unit and is movable in a direction in which the imaging section becomes close to the projecting unit 20 or a direction in which the imaging section becomes distant from the projecting unit 20.

In the above-described embodiments, the substrate 10 on which a solder for soldering a mounted component is printed has hitherto been exemplified as an example of the measurement object 10. However, the measurement object 10 is not limited thereto. Examples of the measurement object 10 include a substrate in which an adhesive for adhering a mounted component is formed, a wiring substrate in which a wiring pattern is formed, a substrate in which glass is printed, and a substrate in which a fluorescent substance is printed.

In the above-described embodiments, the case has hitherto been described in which four images are acquired by shifting the phases of the stripe four times and the phase shift method is applied. However, the embodiments of the present disclosure can be applied, when the number of times of the phase shift and the number of images is three or more.

In the above-described embodiments, the case has hitherto been described in which the optical axis 4 of the imaging unit 20 is vertical to the surface (projecting surface) of the substrate 10. However, the optical axis 4 may not necessarily be vertical to the surface of the substrate. That is, the optical axis 4 of the projecting unit 20 may not necessarily be vertical to the surface of the substrate, as long as the stripe can be projected to the peripheral region of the intersection point 3 between the vertical line and the surface of the substrate 10 when the vertical line is drawn from the projecting unit 20 to the substrate 10. Even in this case, the problem with the shadow or the problem with the halation can appropriately be excluded.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A three-dimensional measuring apparatus comprising:
a projecting unit that projects a stripe to a projectable region which is a peripheral region of an intersection point on a measurement object when a vertical line is drawn down toward the measurement object;
an imaging unit that includes a plurality of imaging regions at which the measurement object to which the stripe is projected is imaged within the projectable region; and
a control unit that performs a process of three-dimensionally measuring the measurement object based on an image imaged by the imaging unit.

2. The three-dimensional measuring apparatus according to claim 1, further comprising:
a moving unit that moves relative positions of the measurement object with respect to the plurality of imaging regions,
wherein the control unit controls the movement of the relative positions by the moving unit such that the moving unit moves one inspection region in the measurement object sequentially to two or more imaging regions among the plurality of imaging regions and controls the imaging unit such that the imaging unit images the inspection region whenever the inspection region is matched with the positions of the imaging regions.

3. The three-dimensional measuring apparatus according to claim 1, further comprising:
a moving unit that moves relative positions of the measurement object with respect to the plurality of imaging regions,
wherein the control unit controls the movement of the relative positions by the moving unit such that the moving unit simultaneously moves two or more inspection regions in the measurement object to two or more imaging regions among the plurality of imaging regions and controls the imaging unit such that the imaging unit simultaneously images the two or more inspection regions.

4. The three-dimensional measuring apparatus according to claim 2,
wherein the control unit switches between a first mode, in which the control unit controls the movement of the relative positions by the moving unit such that the moving unit moves one inspection region in the measurement object sequentially to two or more imaging regions among the plurality of imaging regions and controls the imaging unit such that the imaging unit images the inspection region whenever the inspection region is matched with the positions of the imaging regions, and a second mode, in which the control unit controls the movement of the relative positions by the moving unit such that the moving unit simultaneously moves two or more inspection regions in the measurement object to two or more imaging regions among the plurality of imaging regions and controls the imaging unit such that the imaging unit simultaneously images the two or more inspection regions.

5. The three-dimensional measuring apparatus according to claim 1, wherein at least one of the plurality of imaging regions is located at a position in a range of 180°±90° with respect to the other imaging regions in the projectable region.

6. The three-dimensional measuring apparatus according to claim 5, wherein at least one of the plurality of imaging regions is located at a position in a range of 180°±45° with respect to the other imaging regions in the projectable region.

7. The three-dimensional measuring apparatus according to claim 1, wherein at least one of the plurality of imaging regions is located at a position deviated from 0°, ±90°, and 180° in the projectable region.

8. The three-dimensional measuring apparatus according to claim 1, wherein at least one of the plurality of imaging regions is located at a position deviated from ±45° and ±135° in the projectable region.

9. The three-dimensional measuring apparatus according to claim 1, wherein at least one of the plurality of imaging regions is located at a position deviated from 0°, ±45°, ±90°, ±135°, and 180° in the projectable region.

10. The three-dimensional measuring apparatus according to claim 1, wherein at least one of the plurality of imaging regions is different from the other imaging regions in a distance between the imaging region and the intersection point in the projectable region.

11. The three-dimensional measuring apparatus according to claim 1, wherein the imaging unit includes a plurality of imaging sections corresponding to the plurality of imaging regions.

12. The three-dimensional measuring apparatus according to claim 1, wherein the imaging unit includes an imaging section that is able to singly imaging two or more imaging regions among the plurality of imaging regions.

13. The three-dimensional measuring apparatus according to claim 12, further comprising:
a reflection unit; and
a driving unit that drives the reflection unit so as to switch between a first incident state in which light from one of the plurality of imaging regions is incident on the imaging section and a second incident state in which light from another imaging region is guided to the imaging section by the reflection unit.

14. The three-dimensional measuring apparatus according to claim 1, wherein the projecting unit includes a mask that restricts the projection of the stripe so that the stripe is not projected to a region other than the plurality of imaging regions in the projectable region.
